(19) United States
(12) Patent Application Publication
(10) Pub. No.: US 2014/0166937 A1
(43) Pub. Date: Jun. 19, 2014

(54) LIQUID MIXTURE USED TO TEST AND VALIDATE TEST DEVICES

(71) Applicant: Smiths Heimann GmbH, Wiesbaden (DE)

(72) Inventor: Uwe SIEDENBURG, Essenheim (DE)

(73) Assignee: Smiths Heimann GmbH, Wiesbaden (DE)

(21) Appl. No.: 14/187,979

(22) Filed: Feb. 24, 2014

Related U.S. Application Data
(63) Continuation of application No. PCT/EP2012/065949, filed on Aug. 15, 2012.

(30) Foreign Application Priority Data
Aug. 22, 2011 (DE) 10 2011 081 328.4
Nov. 10, 2011 (DE) 10 2011 118 095.1

(51) Int. Cl. G01V 5/00; G01V 13/00

(52) U.S. Cl. CPC G01V 5/0016; G01V 13/00
USPC 252/408.1

(57) ABSTRACT

The invention relates to a liquid mixture to test and validate test devices for inspecting objects or persons, the mixture containing glycerol. The glycerol portion is at least 90% by weight, preferably approximately 99.5% by weight and the remaining portion is water.

This nonprovisional application is a continuation of International Application No. PCT/EP2012/065949, which was filed on Aug. 15, 2012, and which claims priority to German Patent Application No. 10 2011 081 328.4, which was filed in Germany on Aug. 22, 2011 and to German Patent Application No. 10 2011 118 095.1, which was filed in Germany on Nov. 10, 2011, and which are all herein incorporated by reference.

### BACKGROUND OF THE INVENTION

1. Field of the Invention

The invention relates to a liquid mixture to test and validate test devices for inspecting objects or persons, the mixture containing glycerol.

2. Description of the Background Art

German patent application DE 10 2011 081 328.4 describes the use of inspection systems, in which the persons or objects to be inspected are x-rayed or irradiated in screening devices by electromagnetic rays, for inspecting persons and objects, such as luggage, for hazardous materials such as blasting materials or explosives. As is generally known, such inspection systems are used at airports for inspecting passengers and luggage.

The inspection systems according to a known embodiment contain screening devices in which the objects to be inspected, for example, luggage, are x-rayed or irradiated by x-rays and the transmitted or scattered x-rays are detected and analyzed (DE 10125531-A, DE 19954662-A).

Screening devices are known for inspecting persons, in which the persons to be inspected are irradiated with electromagnetic mm waves and the scattered mm waves are analyzed to obtain an image (DE 102005016106-A).

The screening devices must be tested and validated before being placed into operation. This typically occurs with real hazardous materials, therefore the explosives to be detected. The use of explosives is regulated by law, and moreover they are difficult to handle.

U.S. Pat. No. 5,958,299 discloses an explosive simulation mixture, which contains non-explosive components, whereby the components are selected so that the mixture has a physical form, density, x-ray transmission, and an effective atomic number that corresponds to a selected explosive mixture. An x-ray screening device can be tested for the detection of the specific explosive with the use of the simulation mixture instead of a real explosive. Solid, plastic, and gel-like compositions, which are made up of different components, are described as simulation mixtures.

Inspection systems are also increasingly required to detect liquid explosives and so-called “home-made explosives” as well.

### SUMMARY OF THE INVENTION

It is therefore an object of the invention to provide a mixture that simulates blasting materials or explosives and is not explosive, non-critical in regard to handling, and economic to produce, and behaves like the real hazardous material in a screening device for inspecting objects or persons.

### DETAILED DESCRIPTION

In DE 10 2011 081 328.4, which is incorporated herein by reference, a mixture of glycerol, sodium hydroxide (NaOH), and water is used as the simulation mixture, whereby glycerol and sodium hydroxide are present in a weight ratio of glycerol/sodium hydroxide between 6.5 and 3.8.

According to an embodiment of the invention, a liquid mixture, in which the amount of glycerol is at least 90% by weight, preferably about 99.5% by weight, is used for simulating explosive liquids. The remaining amount is water.

Screening devices intended to detect liquid hazardous materials are tested and validated with this mixture. During the validation it is checked whether the inspection system meets the predefined requirements.

Screening devices intended to detect liquid hazardous materials are tested and validated with this mixture. During the validation it is checked whether the inspection system meets the predefined requirements.

For testing and validating, the liquid simulation mixture according to the invention is placed in an object to be inspected or on a person.

The objects to be inspected, particularly luggage, are x-rayed or irradiated with electromagnetic rays in the screening devices. The transmitted or scattered rays are detected and analyzed.

A use of a mixture according to an exemplary embodiment of the invention is the testing and validating of x-ray screening devices for inspecting persons or objects, particularly luggage, as they have been described as prior in the art in the introduction to the description.

Likewise, the simulation mixture according to the invention can be used to test and validate screening devices in which electromagnetic mm waves are used to inspect persons or objects.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A liquid mixture for testing and validating screening devices for inspecting objects or persons, the mixture containing glycerol, wherein an amount of glycerol is at least 90% by weight or 99.5% by weight, and the remaining amount is water.
